(19) United States
(12) Patent Application Publication
(10) Pub. No.: US 2025/0238955 A1
(43) Pub. Date: Jul. 24, 2025

(54) ESTIMATION APPARATUS, ESTIMATION METHOD, AND NON-TRANSITORY STORAGE MEDIUM

(71) Applicant: NEC Corporation, Minato-ku, Tokyo (JP)

(72) Inventors: Masahiro TANI, Tokyo (JP); Kazufumi Kojima, Tokyo (JP); Keisuke Ikeda, Tokyo (JP)

(73) Assignee: NEC Corporation, Minato-ku, Tokyo (JP)

(21) Appl. No.: 18/703,390

(22) PCT Filed: Nov. 11, 2021
(86) PCT No.: PCT/JP2021/041583

§ 371 Date: Apr. 22, 2024

(51) Int. Cl. G06T 7/73; G06Q 50/00; G06V 10/25

(52) U.S. Cl. CPC G06T 7/74; G06Q 50/01; G06V 10/25; G06T 2207/20221

(57) ABSTRACT

The present invention provides an estimation apparatus (10) including: an acquisition unit (11) that acquires a posted image to be processed being posted on the Internet; a related area determination unit (12) that determines a related area of a target contributor who posted the posted image to be processed; a selection unit (13) that selects a reference image to be collated with the posted image to be processed, based on a determination result of the related area of the target contributor; and a location estimation unit (14) that estimates a location indicated by the posted image to be processed, based on a collation result between the selected reference image and the posted image to be processed.

### TECHNICAL FIELD

The present invention relates to an estimation apparatus, an estimation method, and a program.

### BACKGROUND ART

Patent Document 1 discloses a method in which an image is related to a facility. In the method, when a query image is received, a list of candidate facilities is identified from social media by utilizing a global positioning system (GPS). Then, after a business related concept is detected from an image content, the business related concept is collated with the one extracted from a review and an image stored in a database. Then, a facility related to an image and a review having a highest consistency is replied as a facility having a highest possibility.

Further, Patent Document 2, and Non-Patent Documents 1 to 4 disclose a technique for estimating an activity area of a user.

### RELATED DOCUMENT

### Patent Document

Patent Document 1: Japanese Patent Application Publication No. 2017-130182
Patent Document 2: International Patent Publication No. WO2021/028988

### Non-Patent Document

Non-Patent Document 1: Keisuke Ikeda, Kazufumi Kojima, and Masahiro Tani, “Evaluation of Location Estimation Method that Focuses on Geographical Proximity of Friends”, Institute of Electronics, Information and Communication Engineers, Technical Report, Vol. 119, No. 317, pp. 37 to 42, AI2019-36, November 2019
Non-Patent Document 2: Dan Xu, Peng Cui, Wenwu Zhu, and Shiqiang Yang, “Graph-based residence location inference for social media users”, IEEE Computer Society, IEEE MultiMedia, Volume 21, Issue 4, pp. 76 to 83, October, 2014
Non-Patent Document 3: Backstrom Lars, Eric Sun, and Cameron Marlow, “Find me if you can: Improving geographical prediction with social and spatial proximity” Proceedings of the 19th international conference on World Wide Web, 2010, pp. 61 to 70
Non-Patent Document 4: Liu Zhi, and Yan Huang, “Closeness and structure of friends help to estimate user locations”, International Conference on Database Systems for Advanced Applications, Springer, pp. 33 to 48

### DISCLOSURE OF THE INVENTION

### Technical Problem

A technique for determining a location (a location of a subject in a posted image) indicating a posted image being posted on the Internet has been desired. When metadata (location information) are not associated with a posted image, for example, a unit that collates a reference image attached with location information with the posted image, and determines a location indicated by the posted image, based on a collation result, and the like are known. However, in a case of this unit, basically, it is necessary to collate an enormous number of reference images prepared in such a way as to cover all locations of the entire world with a posted image. Therefore, a time required for processing increases.

An object of the present invention is to shorten a time required for processing in a unit that determines a location indicated by a posted image, based on a collation result between a reference image and the posted image.

### Solution to Problem

The present invention provides an estimation apparatus including:
an acquisition unit that acquires a posted image to be processed being posted on the Internet;
a related area determination unit that determines a related area of a target contributor who posted the posted image to be processed;
a selection unit that selects a reference image to be collated with the posted image to be processed, based on a determination result of the related area of the target contributor; and
a location estimation unit that estimates a location indicated by the posted image to be processed, based on a collation result between the selected reference image and the posted image to be processed.

Further, the present invention provides an estimation method including,
by a computer executing:
   acquisition processing of acquiring a posted image to be processed being posted on the Internet;
   related area determination processing of determining a related area of a target contributor who posted the posted image to be processed;
   selection processing of selecting a reference image to be collated with the posted image to be processed, based on a determination result of the related area of the target contributor; and
   location estimation processing of estimating a location indicated by the posted image to be processed, based on a collation result between the selected reference image and the posted image to be processed.

Further, the present invention provides a program causing a computer to function as:
an acquisition unit that acquires a posted image to be processed being posted on the Internet;
a related area determination unit that determines a related area of a target contributor who posted the posted image to be processed;
a selection unit that selects a reference image to be collated with the posted image to be processed, based on a determination result of the related area of the target contributor; and
a location estimation unit that estimates a location indicated by the posted image to be processed, based on a collation result between the selected reference image and the posted image to be processed.

### Advantageous Effects of Invention

The present invention enables to shorten a time required for processing in a unit that determines a location indicated by a posted image, based on a collation result between a reference image and the posted image.

### BRIEF DESCRIPTION OF THE DRAWINGS

FIG. 1 It is a diagram illustrating an overall image of an estimation apparatus according to a present example embodiment.

FIG. 2 It is one example of a functional block diagram of the estimation apparatus according to the present example embodiment.

FIG. 3 It is one example of a functional block diagram of the estimation apparatus according to the present example embodiment.

FIG. 4 It is a diagram schematically illustrating one example of information to be processed by the estimation apparatus according to the present example embodiment.

FIG. 5 It is a flowchart illustrating one example of a flow of processing by the estimation apparatus according to the present example embodiment.

FIG. 6 It is a flowchart illustrating one example of a flow of processing by the estimation apparatus according to the present example embodiment.

FIG. 7 It is a diagram illustrating one example of a hardware configuration of the estimation apparatus according to the present example embodiment.

FIG. 8 It is a diagram illustrating one example of a screen to be output by the estimation apparatus according to the present example embodiment.

### DESCRIPTION OF EMBODIMENTS

Hereinafter, an example embodiment according to the present invention is described by using the drawings. Note that, in all drawings, a similar constituent element is indicated by a similar reference sign, and description thereof is omitted as necessary.

### <Overview>

An estimation apparatus according to a present example embodiment determines a location indicated by a posted image to be processed, based on a collation result between a reference image and the posted image (a still image and/or a moving image) to be processed. Then, the estimation apparatus includes a feature for shortening a time required for the processing. Specifically, the estimation apparatus determines an area (hereinafter, a “related area”) related to a target contributor who posted a posted image to be processed, and sets, as a target to be collated with the posted image to be processed, a reference image selected based on the related area. By narrowing down a reference image to be collated as described above, a time required for processing is shortened.

Note that, a related area of a target contributor is determined based on at least one of account information of the target contributor, a posted image to be processed, a posted image of the target contributor in past, location information associated with a posted image of the target contributor in past, a posted text posted together with a posted image to be processed, a posted text of the target contributor in past, a language used by the target contributor, post timing of the target contributor, an activity area of the target contributor, and a related area of a related contributor having a predetermined relationship with the target contributor. Determining a related area of a target contributor, based on information as described above, enables to determine an area truly related to the target contributor with high accuracy.

### <Configuration>

Next, a configuration of an estimation apparatus 10 is described.

### “Entire Configuration”

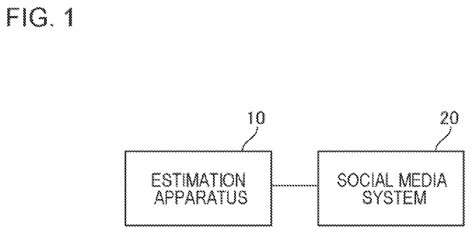

As illustrated in FIG. 1, the estimation apparatus 10 is configured to be communicable with a social media system 20. The estimation apparatus 10 receives various pieces of information from the social media system 20, and performs various pieces of processing, based on the received information.

The social media system 20 is a system that provides a social media service such as a social networking service (SNS). The social media system 20 may include one social media service, or may include a plurality of social media services. The social media service is an online service with which information can be sent (published) and communication can be performed among a plurality of accounts (users) on the Internet (online). The social media service is not limited to an SNS, and includes a messaging service such as a chat, a blog and an electronic bulletin board (a forum site), a video sharing site and an information sharing site, a social game, a social bookmark, and the like.

For example, the social media system 20 includes a server on a cloud and a user terminal. The server may be a social media server, or may be a web server. The user terminal logs in by a user's account via an application programming interface (API) provided by the server, performs inputting, browsing, and the like of a post, and registers connections of accounts such as a friendship and a follow relationship.

### “Functional Configuration”

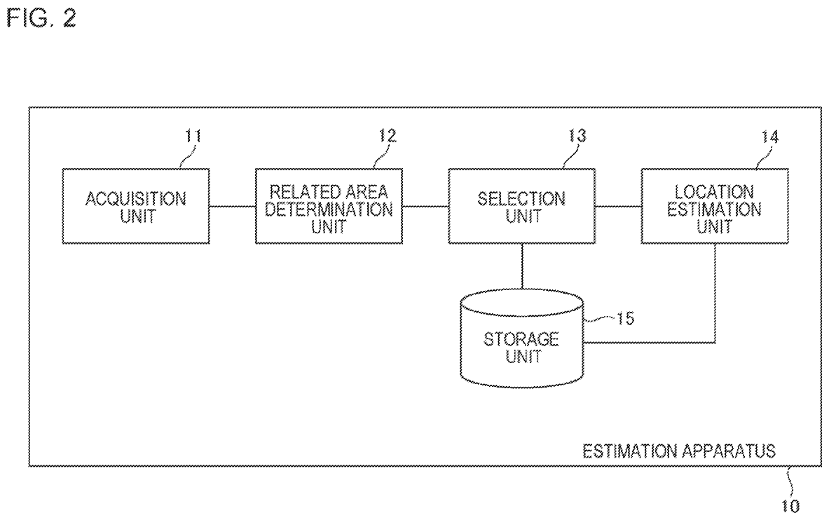

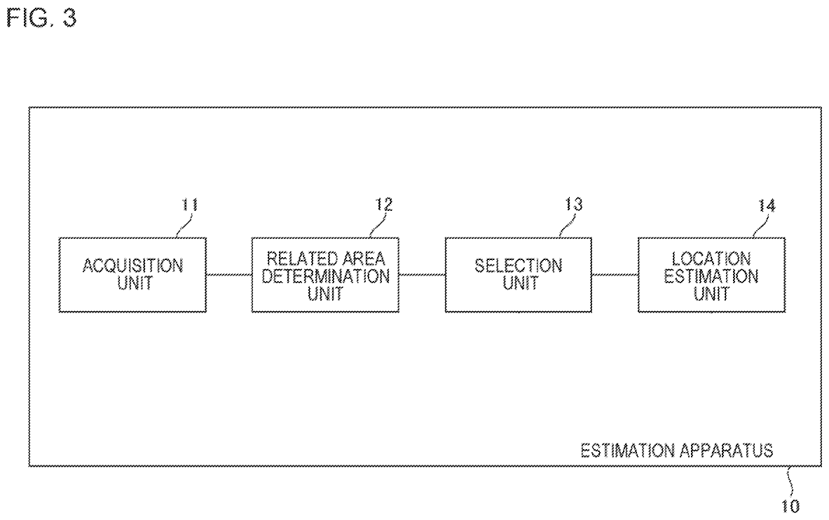

Next, a functional configuration of the estimation apparatus 10 is described. As illustrated in FIG. 2, the estimation apparatus 10 includes an acquisition unit 11, a related area determination unit 12, a selection unit 13, a location estimation unit 14, and a storage unit 15. Note that, as illustrated in FIG. 3, the estimation apparatus 10 may not include the storage unit 15. In this case, an external apparatus configured to be communicable with the estimation apparatus 10 includes the storage unit 15.

The acquisition unit 11 acquires, from the social media system 20, a posted image to be processed being one of posted images posted on the Internet. For example, the acquisition unit 11 acquires, as a posted image to be processed, one posted image specified/selected/determined or the like by an input of an operator operating the estimation apparatus 10. The operator browses a plurality of posted images, and specifies/selects/determines or the like, as a posted image to be processed, a posted image from which a location indicated by the image is desired to know. For example, an operator specifies/selects/determines or the like, as a posted image to be processed, a posted image in which a predetermined event (such as an incident, an accident, or a disaster) or a subject is captured.

The related area determination unit 12 determines a related area of a target contributor who posted a posted image to be processed. The related area of a target contributor is an area related to the target contributor. The related area of a target contributor is determined based on at least one of account information of the target contributor, a posted image to be processed, a posted image of the target contributor in past, location information associated with a posted image of the target contributor in past, a posted text posted together with a posted image to be processed, a posted text of the target contributor in past, a language used by the target contributor, post timing of the target contributor, an activity area of the target contributor, and a related area of a related contributor having a predetermined relationship with the target contributor. Hereinafter, details are described.

### —Determination Based on Account Information of Target Contributor—

The related area determination unit 12 acquires account information of a target contributor from the social media system 20. The account information includes, for example, location information (such as a place name, an address, a post code, and a telephone number) of a residence, location information (such as a place name, an address, a post code, and a telephone number) of a birthplace, location information (such as a place name, an address, a post code, and a telephone number) of a workplace or a school, location information (such as a place name, an address, a post code, and a telephone number) of an alma mater, and the like. The related area determination unit 12 determines, as a related area of a target contributor, an area indicated by account information as described above, or an area further including a periphery thereof. The account information may include another piece of information described in a profile, in addition to the above information. Note that, the related area determination unit 12 may acquire only account information set to be published to another user, or may acquire both of account information set to be published to another user and account information not being set to be published to another user.

There are various algorithms that determine a related area from account information, and any available method can be adopted. For example, an area indicated by a place name may be determined as a related area of a target contributor, or an area indicated by a place name and an area within a predetermined distance from the area may be determined as a related area of a target contributor. Further, an area within a predetermined distance from a place indicated by an address may be determined as a related area of a target contributor. Further, an area indicated by a post code may be determined as a related area of a target contributor, or an area indicated by a post code and an area within a predetermined distance from the area may be determined as a related area of a target contributor. Further, an area indicated by a telephone number (e.g., an area indicated by an area code, or the like) may be determined as a related area of a target contributor, or an area indicated by a telephone number and an area within a predetermined distance from the area may be determined as a related area of a target contributor.

### —Determination (1) Based on Posted Image to be Processed, Posted Image of Target Contributor in Past—

The related area determination unit 12 acquires, from the social media system 20, at least one of a posted image to be processed, and a posted image of a target contributor in past. Then, the related area determination unit 12 determines a related area of the target contributor, based on at least one of a subject of the posted image to be processed, and a subject of the posted image of the target contributor in past.

The related area determination unit 12 determines a rough area indicated by a posted image, based on a subject of the posted image. Then, the related area determination unit 12 determines the determined rough area, as a related area of a target contributor.

There are various units for the rough area, and, for example, the unit may be a country. Further, the rough area may be a unit smaller than a country. For example, in case of Japan, prefectures, municipalities, western Japan, eastern Japan, Tohoku, Kanto, Chubu, Kinki, Chugoku, Shikoku, Kyushu, and the like are exemplified.

For example, the related area determination unit 12 can determine a rough area indicated by a posted image, based on an architectural style of a building being a subject, presence or absence of a telephone pole being a subject, a traffic direction of a vehicle being a subject, a type of a plant being a subject, a type of a product being a subject, clothes of a person being a subject, information on a numberplate of a vehicle being a subject, characters included in a posted image, a place name or an address indicated by the characters, a language of the characters, a symbol, a number, or the like.

For example, a unit that determines a rough area indicated by a posted image, based on an estimation model generated by machine learning, may be conceived, but the example embodiment is not limited thereto.

In addition, as a unit that determines a rough area indicated by a posted image, based on characters detected from the posted image, for example, the following processing may also be conceived.

The related area determination unit 12 determines a rough area indicated by a posted image, based on a predetermined keyword included in characters detected from the posted image.

The keyword is the one utilizable to narrow down an area, and, for example, a place name, a facility name, a product name, a name of a celebrity, a company name, a team name, an event name, and the like are exemplified, but the example embodiment is not limited thereto. For example, the related area determination unit 12 may determine, as a related area of a target contributor, an area indicated by a place name, or may determine, as a related area of a target contributor, an area indicated by a place name and an area within a predetermined distance from the area. Further, the related area determination unit 12 may determine, as a related area of a target contributor, an area in which a facility, a company, or a team indicated by the keyword is present or active. Further, the related area determination unit 12 may determine, as a related area of a target contributor, an area in which an event indicated by the keyword is held. Further, the related area determination unit 12 may determine, as a related area of a target contributor, an area in which a product indicated by the keyword is sold. Further, the related area determination unit 12 may determine, as a related area of a target contributor, an area in which a celebrity indicated by the keyword is active.

The related area determination unit 12 may determine an area indicated by a keyword included in characters detected from a posted image, based on a database in which the keyword, and location information (information indicating an area indicated by a place name, an area in which a facility, a company, or a team is present or active, an area in which an event is held, an area in which a product is sold, an area in which a celebrity is active, and the like) are associated in advance with each other. In addition, the related area determination unit 12 may perform predetermined search such as a web search in which a keyword included in characters detected from a posted image is used as a key, and acquire location information as stored in the above-described database from among a search result.

Note that, when there are a plurality of keywords, an area included in at least one of areas determined based on each of the plurality of keywords may be determined as a related area of a target contributor.

Further, when there are a plurality of posted images, an area included in at least one of rough areas determined based on each of the plurality of posted images may be determined as a related area of a target contributor.

### —Determination (2) Based on Posted Image to be Processed, Posted Image of Target Contributor in Past—

The related area determination unit 12 acquires, from the social media system 20, at least one of a posted image (a moving image) to be processed, and a posted image (a moving image) of a target contributor in past. Then, the related area determination unit 12 determines a related area of the target contributor, based on at least one of a sound related to the posted image to be processed, and a sound related to the posted image of the target contributor in past.

The related area determination unit 12 determines a rough area indicated by a posted image, based on a sound related to the posted image. Then, the related area determination unit 12 determines the determined rough area, as a related area of a target contributor. A concept of the rough area is as described above.

For example, the related area determination unit 12 can determine a rough area indicated by a posted image, based on an environmental sound (a sound generated from an installed object such as a signal or a railroad crossing) included in a sound related to a posted image, a language being used, music being played, or the like.

For example, a unit that determines a rough area indicated by a posted image, based on an estimation model generated by machine learning, may be conceived, but the example embodiment is not limited thereto.

Note that, when there are a plurality of posted images (moving images), an area included in at least one of rough areas determined based on each of the plurality of posted images may be determined as a related area of a target contributor.

—Determination Based on Location Information Associated with Posted Image of Target Contributor in Past—

The related area determination unit 12 acquires, from the social media system 20, location information associated with a posted image of a target contributor in past. Then, the related area determination unit 12 determines a related area of the target contributor, based on location information associated with the posted image of the target contributor in past.

The location information associated with a posted image is, for example, metadata referred to as a geotag, and indicates a location by longitude/latitude. The related area determination unit 12 may determine, as a related area of a target contributor, an area within a predetermined distance from a location indicated by the location information associated with a posted image of a target contributor in past. Further, when there are a plurality of posted images in past being associated with the location information, an area included in at least one of related areas determined based on each of the plurality of posted images in past may be determined as a related area of a target contributor.

—Determination Based on Posted Text Posted Together with Posted Image to be Processed, Posted Text of Target Contributor in Past—

The related area determination unit 12 acquires, from the social media system 20, at least one of a posted text posted together with a posted image to be processed, and a posted text of a target contributor in past. Then, the related area determination unit 12 determines a related area of the target contributor, based on at least one of a keyword included in the posted text posted together with the posted image to be processed, and a keyword included in the posted text of the target contributor in past.

The keyword is the one utilizable to narrow down an area, and, for example, a place name, a facility name, a product name, a name of a celebrity, a company name, a team name, an event name, and the like are exemplified, but the example embodiment is not limited thereto. For example, the related area determination unit 12 may determine, as a related area of a target contributor, an area indicated by a place name, or may determine, as a related area of a target contributor, an area indicated by a place name and an area within a predetermined distance from the area. Further, the related area determination unit 12 may determine, as a related area of a target contributor, an area in which a facility, a company, or a team indicated by the keyword is present or active. Further, the related area determination unit 12 may determine, as a related area of a target contributor, an area in which an event indicated by the keyword is held. Further, the related area determination unit 12 may determine, as a related area of a target contributor, an area in which a product indicated by the keyword is sold. Further, the related area determination unit 12 may determine, as a related area of a target contributor, an area in which a celebrity indicated by the keyword is active.

The related area determination unit 12 may determine an area indicated by a keyword extracted from a posted text, based on a database in which the keyword, and location information (information indicating an area indicated by a place name, an area in which a facility, a company, or a team is present or active, an area in which an event is held, an area in which a product is sold, an area in which a celebrity is active, and the like) are associated in advance with each other. In addition, the related area determination unit 12 may perform predetermined search such as a web search in which a keyword extracted from a posted text is used as a key, and acquire location information as stored in the above-described database from among a search result.

Note that, when there are a plurality of keywords, an area included in at least one of areas determined based on each of the plurality of keywords may be determined as a related area of a target contributor.

### —Determination Based on Language Used by Target Contributor—

The related area determination unit 12 acquires, from the social media system 20, at least one of account information of a target contributor, a posted text posted together with a posted image to be processed, and a posted text of the target contributor in past. Then, the related area determination unit 12 determines a language used by the target contributor in these pieces of information. Then, the related area determination unit 12 determines a related area of the target contributor, based on the determined language. Specifically, the related area determination unit 12 determines, as a related area of a target contributor, an area in which a determined language is used.

The related area determination unit 12 can determine an area in which a determined language is used, based on a database in which a language being used, and location information (information indicating an area in which each language is used) are associated in advance with each other.

### —Determination Based on Post Timing of Target Contributor—

The related area determination unit 12 acquires, from the social media system 20, information indicating post timing of a target contributor in past. Then, the related area determination unit 12 determines a related area of the target contributor, based on post timing of the target contributor.

For example, it is conceived that timing at which there is no post or there are almost no posts is a nighttime, and timing at which there is a post is a daytime. A time zone of an area in which a target contributor is present is determined based on regularity as described above, and an area associated with the determined time zone is determined as a related area of the target contributor.

### —Determination Based on Activity Area of Target Contributor—

The related area determination unit 12 acquires, from the social media system 20, various pieces of information related to a target contributor. Then, the related area determination unit 12 determines an activity area of the target contributor, based on the various pieces of information. Then, the related area determination unit 12 determines, as a related area of the target contributor, the determined activity area of the target contributor.

Determination of an activity area of a target contributor can be achieved by utilizing any available conventional technique. For example, techniques disclosed in Patent Document 2, and Non-Patent Documents 1 to 4 may be utilized, or another technique may be utilized. For example, an activity area of a target contributor may be determined based on a location distribution of the target contributor determined based on account information of the target contributor, and a location distribution determined based on account information of a related contributor having a predetermined relationship with a target user. The location distribution is generated, for example, by a non-parametric method such as a kernel density estimation function.

—Determination Based on Related Area of Related Contributor Having Predetermined Relationship with Target Contributor—

A related contributor is a person having a connection with a target contributor on a service to be provided by the social media system 20. Defining with which person, a person is connected depends on a function provided by the social media system 20. For example, a related contributor is a person corresponding to at least one of a person following a target contributor, a person followed by a target contributor, a person having a mutual follow relationship with a target contributor, a person who mentioned (replied to or mentioned) a posted image or a posted text posted by a target contributor, and a person to which a target contributor mentions (replies to or mentions) a posted image or a posted text.

The related area determination unit 12 determines a related contributor having a predetermined relationship with a target contributor, based on information acquired from the social media system 20. Note that, the social media system 20 may determine a related contributor having a predetermined relationship with a target contributor, and transmit information (such as a list) indicating the determined related contributor to the estimation apparatus 10.

The related area determination unit 12 determines, as a related area of a target contributor, a related area of a related contributor having a predetermined relationship with the target contributor. A related area of a related contributor is determined by a method similar to the above-described determination method of a related area of a target contributor. Specifically, a related area of a related contributor is determined based on account information of the related contributor, a posted image of the related contributor in past, location information associated with a posted image of the related contributor in past, a posted text of the related contributor in past, a language used by the related contributor, post timing of the related contributor, and an activity area of the related contributor.

Note that, the related area determination unit 12 may determine a related area of a target contributor by combining two or more of the above-described plural types of methods. In this case, an area included in at least one of related areas of a target contributor determined by each method may be determined as a related area of the target contributor.

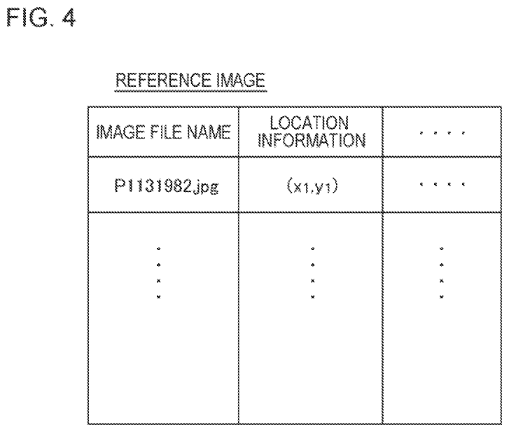

Referring back to FIGS. 2 and 3, the selection unit 13 selects a reference image to be collated with a posted image to be processed, based on a determination result of a related area of a target contributor. As illustrated in FIG. 4, each of a plurality of reference images is stored in advance in the storage unit 15 in association with location information. The location information associated with a reference image indicates a location indicated by each reference image. The location information may be indicated by longitude/latitude, or may be indicated by an address or the like.

The selection unit 13 selects a reference image associated with location information having a predetermined relationship with a related area of a target contributor from among a plurality of reference images stored in the storage unit 15. For example, the selection unit 13 selects a reference image associated with location information indicating a place within a related area of a target contributor.

The location estimation unit 14 estimates a location indicated by a posted image to be processed, based on a collation result between a reference image selected by the selection unit 13, and the posted image to be processed. Specifically, the location estimation unit 14 collates each of reference images selected by the selection unit 13 with a posted image to be processed, and computes a collation score. Then, the location estimation unit 14 outputs, as information indicating a location of the posted image to be processed, location information associated with a reference image in which the collation score satisfies a predetermined condition.

The collation score indicates a degree of similarity between two images. Collation and computation of the collation score can be achieved by utilizing any available conventional technique.

When a larger collation score indicates that two images are more similar to each other, the location estimation unit 14 outputs, as information indicating a location of a posted image to be processed, location information associated with a reference image in which the collation score is equal to or more than a threshold value. Output of information is achieved via any available output apparatus such as a display, a speaker, a projection apparatus, a printer, or a communication apparatus.

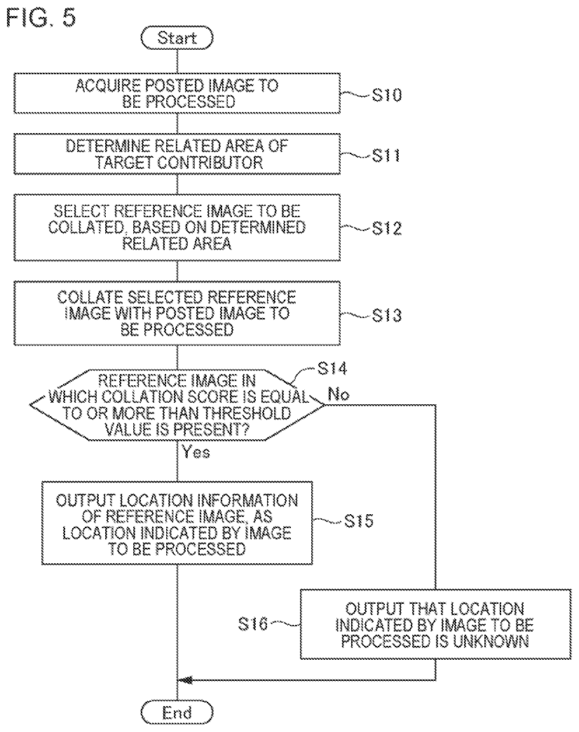

Next, one example of a flow of processing by the estimation apparatus 10 is described by using a flowchart in FIG. 5.

First, the estimation apparatus 10 acquires, from the social media system 20, a posted image to be processing being one of posted images posted on the Internet (S10). For example, the acquisition unit 11 acquires, as a posted image to be processed, one posted image specified/selected/determined or like by an input of an operator operating the estimation apparatus 10.

Next, the estimation apparatus 10 determines a related area of a target contributor who posted the posted image to be processed (S11). The estimation apparatus 10 determines a related area of a target contributor, based on at least one of account information of the target contributor, a posted image to be processed, a posted image of the target contributor in past, location information associated with a posted image of the target contributor in past, a posted text posted together with a posted image to be processed, a posted text of the target contributor in past, a language used by the target contributor, post timing of the target contributor, an activity area of the target contributor, and a related area of a related contributor having a predetermined relationship with the target contributor.

Next, the estimation apparatus 10 selects a reference image to be collated with the posted image to be processed, based on a determination result of the related area of the target contributor (S12), for example, the estimation apparatus selects a reference image associated with location information indicating a place within a related area of a target contributor. The estimation apparatus 10 selects one or a plurality of reference images associated with a location within the related area of the target contributor determined in S11.

Next, the estimation apparatus 10 collates each of the selected reference images with the posted image to be processed, and computes a collation score (S13). Note that, the estimation apparatus 10 does not perform collation of a non-selected reference image with the posted image to be processed. The collation score indicates a degree of similarity between two images. Herein, it is assumed that as two images are more similar to each other, a larger collation score is computed.

When there is a reference image in which the collation score is equal to or more than a threshold value (Yes in S14), the estimation apparatus 10 outputs, as information indicating a location of the posted image to be processed, location information associated with the reference image (S15).

On the other hand, when there is no reference image in which the collation score is equal to or more than the threshold value (No in S14), the estimation apparatus 10 outputs that a location indicated by the posted image to be processed is unknown (S16).

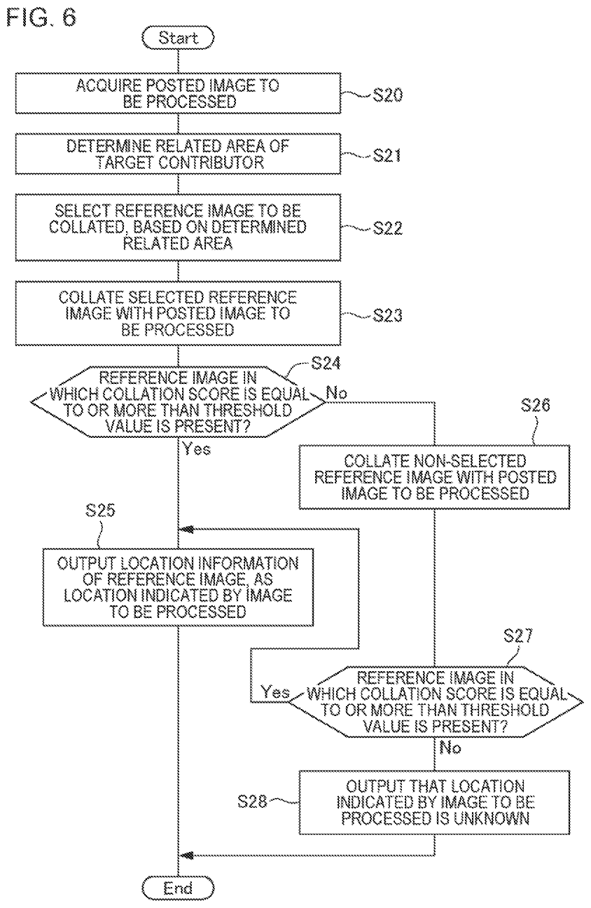

Next, another example of a flow of processing by the estimation apparatus 10 is described by using a flowchart in FIG. 6. Pieces of processing from S20 to S25 are similar to the pieces of processing from S10 to S15 described by using the flowchart in FIG. 5. Hereinafter, processing after a case in which a determination result in S24 becomes No is described.

After a result of collation (S23) between each of reference images selected in S22, and a posted image to be processed acquired in S20, when there is no reference image in which a collation score is equal to or more than a threshold value (No in S24), the estimation apparatus 10 performs collation of each of non-selected reference images in S22 with the posted image to be processed (S26).

Then, when there is a reference image in which the collation score is equal to or more than the threshold value (Yes in S27), the estimation apparatus 10 outputs, as information indicating a location of the posted image to be processed, location information associated with the reference image (S25).

On the other hand, when there is no reference image in which the collation score is equal to or more than the threshold value (No in S27), the estimation apparatus 10 outputs that a location indicated by the posted image to be processed is unknown (S28).

Note that, non-selected reference images may be classified into groups, based on a distance between location information associated with each reference image, and the related area of the target contributor, and pieces of processing from S26 to S28 may be performed in order from a group having the closer distance. Then, when a reference image in which the collation score is equal to or more than the threshold value is found in a certain group, pieces of processing from S26 to S28 may not be performed for the rest of the groups.

Further, the threshold value in S24, and the threshold value in S27 may be the same value, or may be a different value. When the threshold values are different, for example, the threshold value in S24 may be larger than the threshold value in S27.

### Modification Example

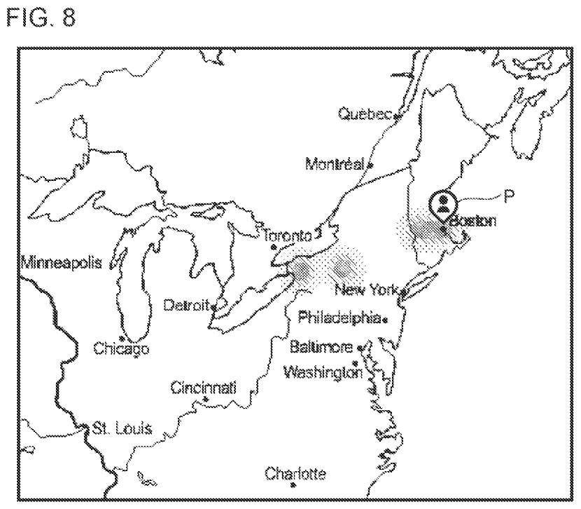

The estimation apparatus 10 may output a screen indicating a related area of a target contributor determined by the related area determination unit 12. FIG. 8 illustrates one example of the screen. On the illustrated screen, a related area of a target contributor is mapped on a map. Specifically, a heatmap indicating a related area of a target contributor, and a pin indicating a location having a highest relation are displayed on a map in a superimposed manner. The heatmap indicates a depth of relation. The depth of relation is determined based on a related score. As the related score increases, the relation is deepened.

There are various computation methods of a related score, but, for example, the following method is conceived. As described above, it is possible to determine a related area of a target contributor by a plurality of methods. In view of the above, a related score of each location is computed depending on by which method, an area is determined as the related area. For example, a related score of a related area determined based on account information of a target contributor may be set higher than a related score of a related area determined by another method. Further, a related score of a related area determined by superimposing by a plurality of methods may be set relatively high. In this case, as the number of times of superimposing increases, the related score may be set higher.

Note that, in the example in FIG. 8, one pin is indicated, but a plurality of pins may be displayed in association with one target contributor. For example, when a plurality of locations at which a related score is equal to or more than a reference value are present, when a plurality of location at which a difference with respect to a highest related score becomes equal to or less than a threshold value are present, or the like, the pin may be displayed in association with each of the plurality of locations.

Outputting a screen as described above enables to provide a related area of a target contributor in such a way that a user or an administrator can visually easily understand.

### “Hardware Configuration”

Next, one example of a hardware configuration of the estimation apparatus 10 is described. Each function unit of the estimation apparatus 10 is achieved by any combination of hardware and software, mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

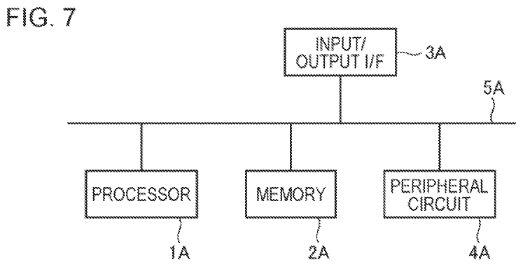

FIG. 7 is a block diagram illustrating a hardware configuration of the estimation apparatus 10. As illustrated in FIG. 7, the estimation apparatus 10 includes a processor 1A, a memory 2A, an input/output interface 3A, a peripheral circuit 4A, and a bus 5A. The peripheral circuit 4A includes various modules. The estimation apparatus 10 may not include the peripheral circuit 4A. Note that, the estimation apparatus 10 may be constituted of a plurality of apparatuses that are physically and/or logically separated. In this case, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on an arithmetic operation result of each module.

### Advantageous Effect

The estimation apparatus 10 according to the present example embodiment determines a location indicated by a posted image to be processed, based on a collation result between a reference image, and the posted image to be processed (a still image and/or a moving image). Then, the estimation apparatus 10 determines a related area of a target contributor who posted the posted image to be processed, and sets, as a target to be collated with the posted image to be processed, a reference image selected based on the related area. Narrowing down a reference image to be collated as described above enables to shorten a time required for processing.

Further, the estimation apparatus 10 determines a related area of a target contributor, based on at least one of account information of the target contributor, a posted image to be processed, a posted image of the target contributor in past, location information associated with a posted image of the target contributor in past, a posted text posted together with a posted image to be processed, a posted text of the target contributor in past, a language used by the target contributor, post timing of the target contributor, an activity area of the target contributor, and a related area of a related contributor having a predetermined relationship with the target contributor. Determining a related area of a target contributor, based on information as described above, enables to determine an area truly related to the target contributor with high accuracy. Consequently, a probability with which a location indicated by a posted image to be processed is included in the related area is increased.

As described above, while the example embodiment according to the present invention has been described with reference to the drawings, these are an example of the present invention, and various configurations other than the above can also be adopted.

Note that, in the present specification, “acquisition” includes at least one of “fetching data stored in another apparatus or a storage medium by an own apparatus (active acquisition)”, based on a user input, or based on an instruction of a program, for example, requesting or inquiring another apparatus and then receiving, accessing another apparatus or a storage medium and then reading, and the like, “inputting data being output from another apparatus to an own apparatus (passive acquisition)”, based on a user input, or based on an instruction of a program, for example, receiving data being distributed (or transmitted, push notified, or the like), and selecting and acquiring from data or information being received, and “generating new data by editing data (text conversion, data rearrangement, extraction of partial data, change in a file format, and the like) or the like, and acquiring the generated new data”.

A part or all of the above-described example embodiments may also be described as the following supplementary notes, but is not limited to the following.
1. An estimation apparatus including:
   an acquisition unit that acquires a posted image to be processed being posted on the Internet;
   a related area determination unit that determines a related area of a target contributor who posted the posted image to be processed;
   a selection unit that selects a reference image to be collated with the posted image to be processed, based on a determination result of the related area of the target contributor; and
   a location estimation unit that estimates a location indicated by the posted image to be processed, based on a collation result between the selected reference image and the posted image to be processed.
2. The estimation apparatus according to supplementary note 1, wherein
   the related area estimation unit
      determines the related area of the target contributor, based on location information included in account information of the target contributor.
3. The estimation apparatus according to supplementary note 1 or 2, wherein
   the related area determination unit
      determines the related area of the target contributor, based on at least one of a subject of the posted image to be processed, and a subject of a posted image of the target contributor in past.
4. The estimation apparatus according to any one of supplementary notes 1 to 3, wherein
   the related area determination unit
      determines the related area of the target contributor, based on at least one of a sound related to the posted image to be processed, and a sound related to a posted image of the target contributor in past.
5. The estimation apparatus according to any one of supplementary notes 1 to 4, wherein
   the related area determination unit
      determines the related area of the target contributor, based on location information associated with a posted image of the target contributor in past.
6. The estimation apparatus according to any one of supplementary notes 1 to 5, wherein
   the related area determination unit
      determines the related area of the target contributor, based on at least one of a keyword included in a posted text being posted together with the posted image to be processed, and a keyword included in a posted text of the target contributor in past.
7. The estimation apparatus according to any one of supplementary notes 1 to 6, wherein
   the related area determination unit
      determines the related area of the target contributor, based on a language used by the target contributor.
8. The estimation apparatus according to any one of supplementary notes 1 to 7, wherein
   the related area determination unit
      determines the related area of the target contributor, based on post timing of the target contributor.
9. The estimation apparatus according to any one of supplementary notes 1 to 8, wherein
   the related area determination unit
      determines the related area of the target contributor, based on an activity area of the target contributor.
10. The estimation apparatus according to any one of supplementary notes 1 to 9, wherein
   the related area determination unit
      determines the related area of the target contributor, based on the related area of a related contributor having a predetermined relationship with the target contributor.
11. The estimation apparatus according to any one of supplementary notes 1 to 10, wherein
   the reference image is associated with location information, and
   the selection unit selects the reference image associated with the location information having a predetermined relationship with the related area of the target contributor.
12. An estimation method including,
   by a computer executing:
      acquisition processing of acquiring a posted image to be processed being posted on the Internet;
      related area determination processing of determining a related area of a target contributor who posted the posted image to be processed;
      selection processing of selecting a reference image to be collated with the posted image to be processed, based on a determination result of the related area of the target contributor; and
      location estimation processing of estimating a location indicated by the posted image to be processed, based on a collation result between the selected reference image and the posted image to be processed.
13. A program causing a computer to function as:
   an acquisition unit that acquires a posted image to be processed being posted on the Internet;
   a related area determination unit that determines a related area of a target contributor who posted the posted image to be processed;
   a selection unit that selects a reference image to be collated with the posted image to be processed, based on a determination result of the related area of the target contributor; and
   a location estimation unit that estimates a location indicated by the posted image to be processed, based on a collation result between the selected reference image and the posted image to be processed.

### REFERENCE SIGNS LIST

10 Estimation apparatus
11 Acquisition unit
12 Related area determination unit
13 Selection unit
14 Location estimation unit
15 Storage unit
20 Social media system
1A Processor
2A Memory
3A Input/output I/F
4A Peripheral circuit
5A Bus

What is claimed is:

1. An estimation apparatus comprising:
at least one memory configured to store one or more instructions; and
at least one processor configured to execute the one or more instructions to:
acquire a posted image to be processed being posted on the Internet;
determine a related area of a target contributor who posted the posted image to be processed;
select a reference image to be collated with the posted image to be processed, based on a determination result of the related area of the target contributor; and
estimate a location indicated by the posted image to be processed, based on a collation result between the selected reference image and the posted image to be processed.

2. The estimation apparatus according to claim 1, wherein
the at least one processor is further configured to execute the one or more instructions to
determine the related area of the target contributor, based on location information included in account information of the target contributor.

3. The estimation apparatus according to claim 1, wherein
the at least one processor is further configured to execute the one or more instructions to
determine the related area of the target contributor, based on at least one of a subject of the posted image to be processed, and a subject of a posted image of the target contributor in past.

4. The estimation apparatus according to claim 1, wherein
the at least one processor is further configured to execute the one or more instructions to
determine the related area of the target contributor, based on at least one of a sound related to the posted image to be processed, and a sound related to a posted image of the target contributor in past.

5. The estimation apparatus according to claim 1, wherein
the at least one processor is further configured to execute the one or more instructions to
determine the related area of the target contributor, based on location information associated with a posted image of the target contributor in past.

6. The estimation apparatus according to claim 1, wherein
the at least one processor is further configured to execute the one or more instructions to
determine the related area of the target contributor, based on at least one of a keyword included in a posted text being posted together with the posted image to be processed, and a keyword included in a posted text of the target contributor in past.

7. The estimation apparatus according to claim 1, wherein
the at least one processor is further configured to execute the one or more instructions to
determine the related area of the target contributor, based on a language used by the target contributor.

8. The estimation apparatus according to claim 1, wherein
the at least one processor is further configured to execute the one or more instructions to
determine the related area of the target contributor, based on post timing of the target contributor.

9. The estimation apparatus according to claim 1, wherein
the at least one processor is further configured to execute the one or more instructions to
determine the related area of the target contributor, based on an activity area of the target contributor.

10. The estimation apparatus according to claim 1, wherein
the at least one processor is further configured to execute the one or more instructions to
determine the related area of the target contributor, based on the related area of a related contributor having a predetermined relationship with the target contributor.

11. The estimation apparatus according to claim 1, wherein
the reference image is associated with location information, and
the at least one processor is further configured to execute the one or more instructions to select the reference image associated with the location information having a predetermined relationship with the related area of the target contributor.

12. An estimation method comprising,
by a computer executing:
acquiring a posted image to be processed being posted on the Internet;
determining a related area of a target contributor who posted the posted image to be processed;
selecting a reference image to be collated with the posted image to be processed, based on a determination result of the related area of the target contributor; and
estimating a location indicated by the posted image to be processed, based on a collation result between the selected reference image and the posted image to be processed.

13. A non-transitory storage medium storing a program causing a computer to:
acquire a posted image to be processed being posted on the Internet;
determine a related area of a target contributor who posted the posted image to be processed;
select a reference image to be collated with the posted image to be processed, based on a determination result of the related area of the target contributor; and
estimate a location indicated by the posted image to be processed, based on a collation result between the selected reference image and the posted image to be processed.

14. The estimation method according to claim 12, wherein
the computer
determines the related area of the target contributor, based on location information included in account information of the target contributor.

15. The estimation method according to claim 12, wherein
the computer
determines the related area of the target contributor, based on at least one of a subject of the posted image to be processed, and a subject of a posted image of the target contributor in past.

16. The estimation method according to claim 12, wherein
the computer
determines the related area of the target contributor, based on at least one of a sound related to the posted image to be processed, and a sound related to a posted image of the target contributor in past.

17. The estimation method according to claim 12, wherein
the computer
determines the related area of the target contributor, based on location information associated with a posted image of the target contributor in past.

18. The non-transitory storage medium according to claim 13, wherein
the program causing the computer to
determine the related area of the target contributor, based on location information included in account information of the target contributor.

19. The non-transitory storage medium according to claim 13, wherein
the program causing the computer to
determine the related area of the target contributor, based on at least one of a subject of the posted image to be processed, and a subject of a posted image of the target contributor in past.

20. The non-transitory storage medium according to claim 13, wherein
the program causing the computer to
determine the related area of the target contributor, based on at least one of a sound related to the posted image to be processed, and a sound related to a posted image of the target contributor in past.
